(19) United States
(12) Patent Application Publication
(10) Pub. No.: US 2025/0390786 A1
(43) Pub. Date: Dec. 25, 2025

(54) COLLABORATIVE ARTIFICIAL INTELLIGENCE (AI) PREFERENCE MODEL FOR GENERATIVE AI MODEL SELECTION

(71) Applicant: Boomi, LP, Conshohocken, PA (US)

(72) Inventors: Michael J. HUDSON, Delray Beach, FL (US); Swagata ASHWANI, San Francisco, CA (US)

(73) Assignee: Boomi, LP, Conshohocken, PA (US)

(21) Appl. No.: 18/750,810

(22) Filed: Jun. 21, 2024

(51) Int. Cl. G06N 20/00

(52) U.S. Cl. CPC G06N 20/00

(57) ABSTRACT

It is a challenge to ensure the reliability of generative artificial intelligence (AI), due to a number of factors, including uncertainty, ambiguity, the absence of ground truth, variability among models, ethical implications, and the like. Accordingly, embodiments implement a chatbot that is capable of determining a user's intent, uses a preference model to select one of a plurality of generative AI models that is best suited for that intent, and responds using the selected generative AI model. In addition, the chatbot may capture users' sentiments in their replies and update the preference model accordingly, for continual improvement in the selection of the generative AI models using reinforcement learning from human feedback. The preference model may also account for other metrics of each generative AI model, such as performance, utility, and ethics.

### BACKGROUND

### Field of the Invention

The embodiments described herein are generally directed to artificial intelligence (AI), and, more particularly, to a collaborative AI preference model for generative AI model selection.

### Description of the Related Art

The rise of generative language models, such as ChatGPT, developed by OpenAI of San Francisco, California, and Gemini, developed by Google LLC of Mountain View, California, has brought about a paradigm shift in information retrieval. However, it is a challenge to ensure the reliability of the responses output by these generative language models, due to uncertainty, ambiguity, the absence of ground truth, variability among models, ethical implications, and/or the like. As a result, users of these models may encounter difficulties in discerning the trustworthiness of responses, particularly in critical scenarios.

In particular, generative AI models operate probabilistically. This may lead to responses that lack certainty and accuracy. This is especially true in the event of complex queries.

In addition, the inherent ambiguity of human language makes it difficult for generative AI models to correctly interpret every nuance. This can result in contextually incorrect or misleading responses.

In addition, generative artificial intelligence lacks a definitive ground truth for objective assessment. This makes it complex to evaluate the accuracy of their responses.

In addition, different generative AI models exhibit varying levels of proficiency levels in different contexts. This complicates the selection of an appropriate generative AI model.

In addition, users may need to query multiple generative AI models to obtain a suitable response. This adds complexity and time overhead.

In addition, the reliance on unreliable responses from generative AI models raises ethical concerns. This is especially true in critical domains.

### SUMMARY

Accordingly, systems, methods, and non-transitory computer-readable media are disclosed for a collaborative AI preference model for generative AI model selection that addresses one or more of these and other problems discovered by the inventors.

In an embodiment, a method comprises using at least one hardware processor to, during a session with a user, in each of one or more iterations: receive an input from the user via a graphical user interface; and produce a generative artificial intelligence (AI) response by applying an intent model to the input to determine an intent of the input, applying a preference model to the determined intent to determine at least one of a plurality of generative artificial intelligence (AI) models, applying the determined at least one of the plurality of generative AI models to the input to produce a response, and displaying the response to the user within the graphical user interface.

The intent model may comprise a classifier that classifies the input into one of a plurality of intent classes, and wherein the determined intent comprises the one intent class into which the intent model classified the input. The intent model may comprise a machine-learning classifier. The preference model may comprise, for each of the plurality of intent classes and for each of the plurality of generative AI models, a preference score, and the preference model may determine the at least one of the plurality of generative AI models based on the preference scores for the one intent class across the plurality of generative AI models. The plurality of intent classes may comprise one or more of a summarization class, indicating that the user is requesting a summarization of information, a question-and-answer class, indicating that the user is asking a question, or a text-to-code class, indicating that the user is requesting source code to be generated. The plurality of intent classes may comprise the summarization class, the question-and-answer class, and the text-to-code class.

The one or more iterations may be a plurality of iterations, and the method may further comprise using the at least one hardware processor to, during the session with the user, in at least one of the plurality of iterations that is subsequent to a first iteration, such that the input is a reply to a prior response: apply a sentiment model to the reply to predict a sentiment of the reply; and update the preference model based on the predicted sentiment. The sentiment model may comprise a classifier that classifies the reply into one of a plurality of sentiment classes, and the predicted sentiment may comprise the one sentiment class into which the sentiment model classified the reply. The sentiment model may comprise a machine-learning classifier. The plurality of sentiment classes may comprise a positive class, indicating a positive reaction to the prior response, and a negative class, indicating a negative reaction to the prior response.

The plurality of generative AI models may comprise at least one large language model. The plurality of generative AI models may comprise at least one code-completion model. The plurality of generative AI models may comprise two or more large language models.

The method may further comprise using the at least one hardware processor to, in at least one of the one or more iterations, determine whether or not a gold-standard response exists for the input. The one or more iterations may be a subset of a plurality of iterations, and the method may further comprise using the at least one hardware processor to, in at least one of the plurality of iterations: determine whether or not a gold-standard response exists for the input; when determining that the gold-standard response exists for the input, display the gold-standard response to the user within the graphical user interface without producing the generative AI response; and when determining that the gold-standard response does not exist for the input, produce the generative AI response.

The graphical user interface may comprise a screen that includes a chat box, each input may be received through the chat box, and each response may be displayed on the screen. The graphical user interface may be implemented by a server application of an Integration Platform as a Service (iPaaS) platform. At least one of the plurality of generative AI models may be trained on historical integration data collected from a plurality of integration platforms on the iPaaS platform.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates an example data flow for a collaborative AI preference model for generative AI model selection, according to an embodiment;

FIG. 4 illustrates a process for a collaborative AI preference model for generative AI model selection, according to an embodiment; and

FIG. 5 illustrates a screen of a graphical user interface, implementing a chat session, according to an embodiment.

### DETAILED DESCRIPTION

In an embodiment, systems, methods, and non-transitory computer-readable media are disclosed for a collaborative AI preference model for generative AI model selection. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. INFRASTRUCTURE

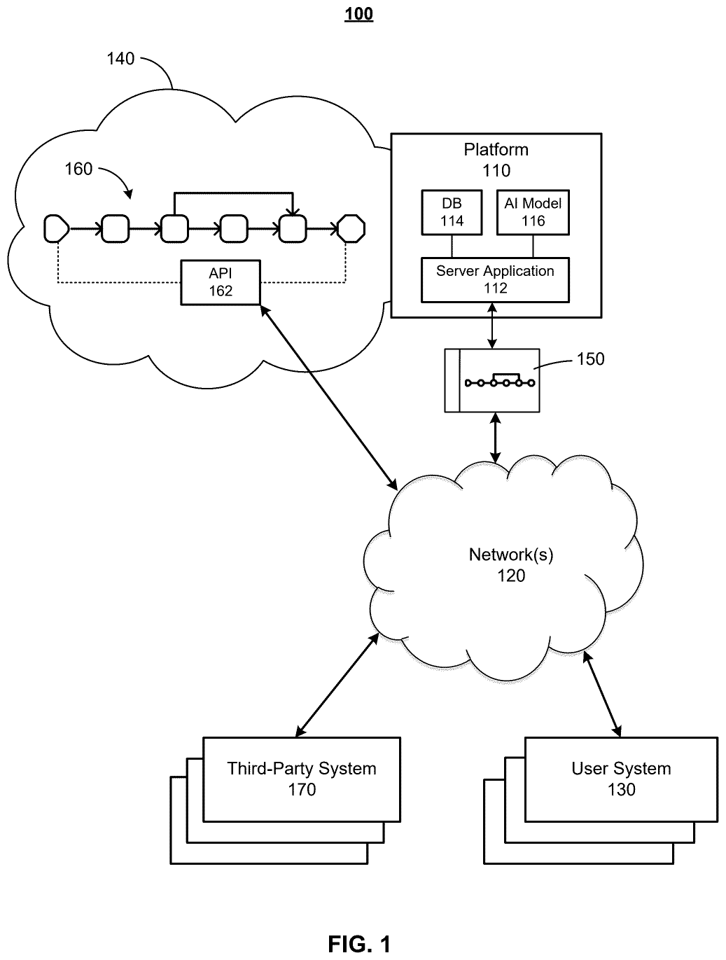

FIG. 1 illustrates an example infrastructure 100, in which one or more of the processes described herein may be implemented, according to an embodiment. Infrastructure 100 may comprise a platform 110 which hosts and/or executes one or more of the disclosed processes, which may be implemented in software and/or hardware. In particular, platform 110 may execute a server application 112, host a database 114 that may store data used by server application 112, and/or execute an artificial intelligence (AI) model 116 that may process data generated by server application 112 and/or stored in database 114 and/or generate data for use by server application 112 and/or storage in database 114. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed.

Platform 110 may be communicatively connected to one or more networks 120. Network(s) 120 enable communication between platform 110 and user system(s) 130. Network(s) 120 may comprise the Internet, and communication through network(s) 120 may utilize standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to a plurality of user systems 130 through a single set of network(s) 120, it should be understood that platform 110 may be connected to different user systems 130 via different sets of one or more networks. For example, platform 110 may be connected to a subset of user systems 130 via the Internet, but may be connected to another subset of user systems 130 via an intranet.

While only a few user systems 130 are illustrated, it should be understood that platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal or professional workstation of an integration developer that has a user account for accessing server application 112 on platform 110. It should be understood that the integration developer may be anywhere from a novice, with little to no prior experience in integration development, to an expert, with many years of experience in integration development. Platform 110 may be an iPaaS platform, in which case, each user account may be associated with an overarching organizational account for managing an integration platform on the iPaaS platform.

Server application 112 may manage an integration environment 140. In particular, server application 112 may provide a user interface 150 and backend functionality, including one or more of the processes disclosed herein, to enable users, via user systems 130, to construct, develop, modify, save, delete, test, deploy, un-deploy, and/or otherwise manage integration processes 160 within integration environment 140. User interface 150 may comprise a graphical user interface that implements a low-code environment, including potentially a no-code environment, in which users may construct integration processes 160.

The user of a user system 130 may authenticate with platform 110 using standard authentication means, to access server application 112 in accordance with permissions or roles of the associated user account. The user may then interact with server application 112 to manage one or more integration processes 160, for example, within a larger integration platform within integration environment 140. It should be understood that multiple users, on multiple user systems 130, may manage the same integration process(es) 160 and/or different integration processes 160 in this manner, according to the permissions or roles of their associated user accounts.

Although only a single integration process 160 is illustrated, it should be understood that, in reality, integration environment 140 may comprise any number of integration processes 160. In an embodiment, integration environment 140 supports integration platform as a service (iPaaS). In this case, integration environment 140 may comprise one or a plurality of integration platforms that each comprises one or a plurality of integration processes 160. Each integration platform may be associated with an organization, which may be associated with one or more user accounts by which respective user(s) manage the organization's integration platform, including the various integration process(es) 160.

An integration process 160 may represent a transaction involving the integration of data between two or more systems, and may comprise a series of elements that specify logic and transformation requirements for the data to be integrated. Each element, which may also be referred to herein as a “step” and have a visual representation referred to herein as a “shape,” may transform, route, and/or otherwise manipulate data to attain an end result from input data. For example, a basic integration process 160 may receive data from one or more data sources (e.g., via an application programming interface 162 of the integration process 160), manipulate the received data in a specified manner (e.g., including analyzing, normalizing, altering, updated, enhancing, and/or augmenting the received data), and send the manipulated data to one or more specified destinations (e.g., via an application programming interface of each destination). An integration process 160 may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software.

The functionality of server application 112 may include a process for constructing an integration process 160 within one or more screens of a graphical user interface of user interface 150. Embodiments of such functionality are disclosed, for example, in U.S. Pat. No. 8,533,661, issued on Sep. 10, 2013, and U.S. Pat. No. 11,886,965, issued on Jan. 30, 2024, which are both hereby incorporated herein by reference as if set forth in full, and referred to hereafter as “the GUI applications.” In particular, the GUI applications describe functionality that enables the construction of integration processes 160 on a virtual canvas, by even novice users.

Each integration process 160, when deployed, may be communicatively coupled to network(s) 120. For example, each integration process 160 may comprise an application programming interface (API) 162 that enables clients to access integration process 160 via network(s) 120. A client may push data to integration process 160 through application programming interface 162, and/or pull data from integration process 160 through application programming interface 162.

One or more third-party systems 170 may be communicatively connected to network(s) 120, such that each third-party system 170 may communicate with an integration process 160 in integration environment 140 via application programming interface 162. Third-party system 170 may host and/or execute a software application that pushes data to integration process 160 and/or pulls data from integration process 160, via application programming interface 162. Additionally or alternatively, an integration process 160 may push data to a software application on third-party system 170 and/or pull data from a software application on third-party system 170, via an application programming interface of the third-party system 170. Thus, third-party system 170 may be a client or consumer of one or more integration processes 160, a data source for one or more integration processes 160, and/or the like. As examples, the software application on third-party system 170 may comprise, without limitation, enterprise resource planning (ERP) software, customer relationship management (CRM) software, accounting software, and/or the like.

### 2. EXAMPLE PROCESSING SYSTEM

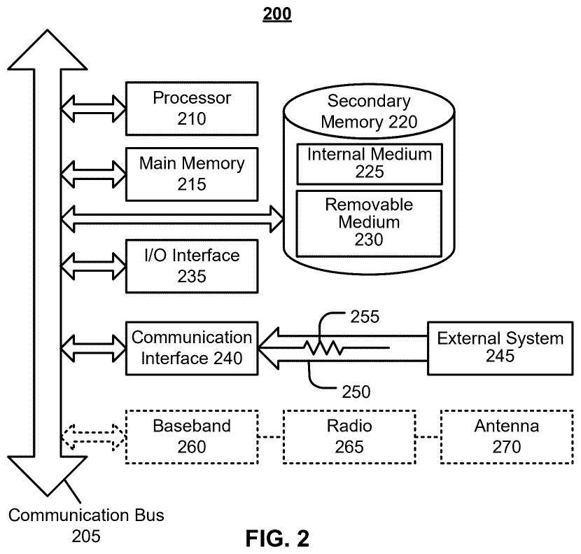

FIG. 2 illustrates an example processing system, by which one or more of the processes described herein may be executed, according to an embodiment. For example, system 200 may be used to store and/or execute server application 112, and/or may represent components of platform 110, user system(s) 130, third-party system 170, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, then baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. DATA FLOW

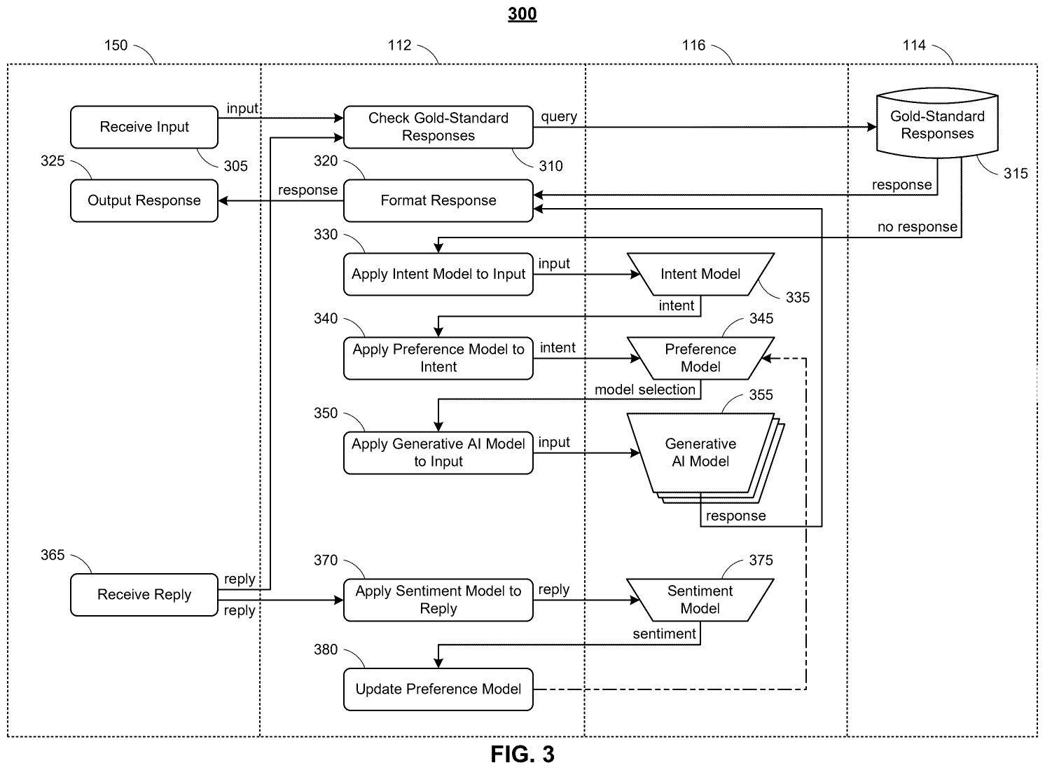

FIG. 3 illustrates an example data flow 300 for a collaborative AI preference model for generative AI model selection, according to an embodiment. In data flow 300, user interface 150 may implement modules 305, 325, and 365, server application 112 may implement modules 310, 320, 330, 340, 350, 370, and 380, database 114 may store gold-standard responses 315, and AI model 116 may comprise intent model 335, preference model 345, a plurality of generative AI models 355, and a sentiment model 375. Modules 305, 310, 320, 325, 330, 340, 350, 365, 370, and 380, and models 335, 345, 355, and 375 are preferably implemented as software modules, but could also be implemented as hardware modules or as modules comprising a combination of hardware and software.

Within a graphical user interface of user interface 150, a user may be provided with a screen comprising a chat box. The screen, comprising the chat box, may be designed for users to obtain support for an integration platform being managed by the user in integration environment 140 of platform 110. Alternatively or additionally, the chat box may be incorporated into a screen for constructing an integration process 160 on a virtual canvas, as described, for example, in the GUI applications. Alternatively or additionally, the chat box may be incorporated in another screen of the graphical user interface. In any case, the user may initiate a chat session with a chatbot, implemented by AI model 116, by inputting text (e.g., questions, requests, etc.) into the chat box.

Embodiments will primarily be described herein as being implemented on an iPaaS platform for use in the context of integration. For instance, each user of server application 112 may chat with the chatbot, implemented by AI model 116, to ask questions or make requests related to the user's integration platform or integration in general, integration process(es) 160 existing on the user's integration platform, an integration process 160 being constructed in the graphical user interface, an integration process 160 to be constructed for the user's integration platform, individual components or subsets of components of an integration process 160, and/or the like. However, disclosed embodiments are not limited to an iPaaS platform or to the context of integration. Rather, disclosed embodiments may be utilized in any context in which a chatbot might be beneficial, including in contexts outside and/or independent of the integration of data, including customer service, technical support, professional drafting, software engineering, creative writing, and/or the like. Thus, disclosed embodiments should not be understood to be limited to the context of integration.

Module 305 receives an input. Receiving the input may comprise receiving the input from a user via a graphical user interface of user interface 150. In an alternative or additional embodiment which provides an application programming interface, receiving the input may comprise receiving the input from an external system as an input parameter to a remote procedure call to a function of the application programming interface. In either case, the input may comprise text that has been input by the user into a chat box of a screen of a graphical user interface. This text may represent an initial question, request, and/or the like. The text may be input in natural language, as if the user was speaking with another human. As used herein, the term “natural language” or “natural-language” refers to language, including grammar, that would be expected in a normal conversation between two humans. However, the text that may be input into the chat box is not limited to natural language or any other format. Rather, the chat box represents a free-form input into which the user may intuitively input any text in any format. In an additional or alternative embodiment, the chat box may be configured to receive other forms of information, such as documents, images, video, audio, and/or the like. Regardless of the format of the input, when an input is submitted in the chat box, the input is received by module 305, and provided by module 305 to module 310.

Module 310 may determine whether or not a gold-standard response 315 exists for the input. In particular, module 310 may check the input against a plurality of gold-standard responses 315, stored in database 114. Each of the plurality of gold-standard responses 315 may represent an established answer to a common input. A common input may be an input (e.g., question or request) that many users have input in the past. For instance, common inputs may be determined based on a distribution of input data acquired from historical chat sessions. For each common input, a gold-standard response 315 may be generated by a human expert (e.g., an agent of the operator of platform 110), with or without the aid of generative artificial intelligence, and then stored in database 114 in association with a representation of the input. The representation of the input may comprise or consist of the exact input, a portion of the input, a set of keywords representing the input, and/or the like. The plurality of gold-standard responses 315 may be indexed by the representation of the input, such that the gold-standard response 315, if one exists, for an input can be easily retrieved based on the input.

When a gold-standard response 315 exists for the input, that gold-standard response 315 may be returned to module 320. In this case, no generative AI response will be produced, since the best possible response is already available as a predefined gold-standard response 315. In other words, the existence of a gold-standard response 315 for a given input means that the production of a generative AI response is not necessary, and therefore, may be bypassed. Conversely, when a gold-standard response does not exist for the input, a generative AI response may be produced.

Module 320 may format the response that is returned. This formatting may comprise customizing the response to the user. For instance, the response may comprise a template with one or more placeholders into which user-specific information may be inserted. Alternatively or additionally, formatting the response may comprise generating a data structure (e.g., in a markup language, such as HTML, extensible Markup Language (XML), etc.), comprising a representation of the response, for rendering in the graphical user interface. The formatting may be agnostic to the source of the response (i.e., whether the response is a gold-standard response 315 or is generated by a generative AI model 355). In any case, the formatted response may be provided to module 325. In an alternative embodiment, the raw response may be provided to module 325, in which case module 320 may simply relay the response to module 325 without formatting or be omitted altogether.

Module 325 may output the response. Outputting the response may comprise displaying the response to the user within the graphical user interface of user interface 150. In particular, module 325 may display the formatted (or raw) response within a screen of the graphical user interface. In a preferred embodiment, the screen is the same screen that comprises the chat box. That is to say that the graphical user interface comprises a screen that includes a chat box, each input is received through the chat box, and each response is displayed on the screen. In this case, the chat session may be implemented as a running real-time dialogue, between the user and the artificial intelligence, within a single screen of the graphical user interface. Such a format may be intuitive for users that are used to similar interfaces for text messaging, real-time chats with other users, and the like. Alternatively, the formatted response could be provided in a different screen of the graphical user interface than the chat box. In an alternative or additional embodiment which provides an application programming interface, outputting the response may comprise sending the response to an external system in response to a call to a function of the application programming interface.

When no gold-standard response 315 exists for the input, a generative AI response may be produced. In particular, module 330 may be triggered to initiate the generation of a generative AI response. In an alternative embodiment, gold-standard responses 315 are not used. In this case, module 310 and gold-standard responses 315 may be omitted, and the input from module 305 may be provided directly to module 330. In other words, in this alternative embodiment, a generative AI response is produced for every input.

Module 330 may apply an intent model 335 to the input to determine an intent of the input. In an embodiment, intent model 335 is a classifier that classifies the input into one of a plurality of intent classes. Each of the plurality of intent classes may represent a purpose for which the user intends to use the generative artificial intelligence. For example, in the context of an integration platform, the plurality of intent classes may comprise a summarization class, which indicates that the user's intent is to request the generative artificial intelligence to summarize information, a question-and-answer (Q/A) class, which indicates that the user's intent is to ask the generative artificial intelligence a question for which the user desires a response, a text-to-code class, which indicates that the user's intent is to request the generative artificial intelligence to generate source code (e.g., for an entire integration process 160 or one or more components of an integration process 160), and/or the like.

Intent model 335 may comprise any suitable model. One suitable class of models for intent classification is the named-entity recognition (NER) class of models, which comprise dictionary-based, rules-based, and machine-learning models, including deep-learning models. Essentially, an NER model detects and classifies entities in the input. In a preferred embodiment, intent model 335 comprises or consists of a machine-learning model, such as a small language model, that is trained to classify the input into one of the plurality of intent classes. In this case, intent model 335 may comprise a language model that is based on the transformer architecture, such as Bidirectional Encoder Representations from Transformers (BERT), as disclosed in J. Devlin et al., “BERT: Pre-training of Deep Bidirectional Transformers for Language Understanding,” arXiv: 1810.04805, which is hereby incorporated herein by reference as if set forth in full, or any of its extensions, such as Robustly Optimised BERT pretraining Approach (ROBERTA), A Lite BERT (ALBERT), Distilled BERT (DistilBERT), StructBERT, or Decoding-enhanced BERT with disentangled Attention (DeBERTa). Other examples of suitable models include large language models, such as any of the GPT-n series of large language models, created by OpenAI™ of San Francisco, California, the Claude family of large language models (e.g., Claude 3 Opus) developed by Anthropic PBC of San Francisco, California, the Falcon large language model (e.g., Falcon 180B) released by the United Arab Emirates' Technology Innovation Institute (TII), the Large Language Model Meta AI (LLaMA) model (e.g., LLAMA 2) released by Meta AI of New York, New York, the Gemini model, the Mistral family of models released by Mistral AI of Paris, France, and the like. In an embodiment in which a large language model is used as intent model 335, intent model 335 may be asked to classify an input into one of the plurality of intent classes. Alternatively, intent model 335 may comprise another type of machine-learning classifier.

In an embodiment, in which intent model 335 comprises a machine-learning model, intent model 335 may be trained using supervised learning. In particular, a training dataset may be generated, for example, from historical chat sessions. The training dataset may comprise a plurality of inputs. Each input in the plurality of inputs may be labeled with a ground-truth intent class from the plurality of intent classes. Over each of a plurality of training iterations, intent model 335 may be applied to each of a subset of labeled inputs in the training dataset to produce a predicted intent class, the predicted intent class may be compared, according to a loss function, to the ground-truth intent class with which the input is labeled, and the weights of intent model 335 may be updated to minimize the error output by the loss function. Intent model 335 may then be evaluated using a different, smaller subset of labeled inputs in the training dataset to determine the accuracy of intent model 335, according to any suitable accuracy metric. If intent model 335 does not have suitable accuracy (e.g., the value of the accuracy metric is below a predetermined threshold), intent model 335 may be retrained until it is able to classify intent with suitable accuracy.

In an embodiment, intent model 335 may utilize a multi-dimensional vector space. In particular, each input may be converted into a vector embedding representing the location of the input within the vector space, according to an embedding algorithm. Examples of embedding algorithms include, without limitation, Word2Vec, Global Vectors for Word Representation (GloVe), Term Frequency and Inverse Document Frequency (TF-IDF), BERT, Doc2Vec, Skip-Thought vector embedding, the Probabilistic Latent Semantic Indexing (PLSI) model, Latent Dirichlet Allocation (LDA), and the like. Each vector embedding may be a vector comprising a plurality of values that each represents the value of the input in one of the plurality of dimensions of the vector space. The vector space may represent intent, such that the vector embedding represents a location of the vector embedding within an intent space. During training, the inputs from historical chat sessions may be converted into vector embeddings, according to the embedding algorithm, and grouped into clusters according to a suitable clustering algorithm (e.g., K-Means), with each cluster representing one of the plurality of intent classes. During subsequent operation, intent model 335 may convert each input into a vector embedding, according to the same embedding algorithm, determine the nearest cluster to that vector embedding according to any suitable similarity metric (e.g., Euclidean distance, Manhattan distance, Cosine distance, Hamming distance, Minkowski distance, Chebyshev distance, Jaccard distance, Haversine distance, Sorensen-Dice distance, etc.), and output the intent class associated with that nearest cluster as the determined intent of the input.

Module 340 may receive the intent, determined by intent model 335 (e.g., the intent class into which intent model 335 classified the input), and apply preference model 345 to that determined intent to determine one of a plurality of generative AI models 355 to be used to generate a response to the input. It should be understood that this determination is a prediction of which of the plurality of generative AI models 355 will produce an output that is preferred by the user. In other words, each of the plurality of generative AI models 355 may be capable of producing an output, but one of the plurality of generative AI models 355 may be better, in terms of the user's preference, at producing an output for the determined intent than the other ones of the plurality of generative AI models 355.

Preference model 345 may comprise a small language model that selects one of the plurality of generative AI models 335 based on the intent, determined by intent model 335, and the past performance of that generative AI model 335 for that intent. In an embodiment, preference model 345 may comprise, for each of the plurality of generative AI models 355 and for each of the plurality of intent classes, a preference score representing the preference of that generative AI model 355 for that intent class. It should be understood that the preference score for a given generative AI model 355 and intent class should be relative to the preference score for the same intent class for other generative AI models 355, such that a higher preference score represents higher preference. For example, all of the preference scores for all of the plurality of generative AI models 355 for a given intent class may sum to one, such that each preference score represents the probability that the associated generative AI model 355 will produce the most preferred response for that intent class. In this case, preference model 345 may select the one generative AI model 355, from among the plurality of generative AI models 355, having the highest preference score for the intent class output by intent model 335.

A preference model 345 may be maintained for each user of server application 112. In other words, AI model 116 may comprise a preference model 345 for each of the plurality of users of server application 112. Within a preference model 345 for a given user, the preference score of each generative AI model 355 may initially be based on a performance metric, utility metric, ethics metric, and/or the like, for that generative AI model 355. Thus, the preference model 345 may start out the same for each user. However, once the user begins interacting with AI model 116, via one or more chat sessions, the preference scores in preference model 345 may be updated based on a preference metric, representing feedback from the user, such that the preference model 345 evolves over time and diverges from other users' preference models 345, to match the user's specific preferences.

In an embodiment, the overall preference score of each generative AI model 355 for each of the plurality of intent classes, is computed by preference model 345 from a combination of the preference metric and one or more other metrics, such as a performance metric, utility metric, ethics metric, and/or the like, mentioned above. The preference metric may be updated, over time, based on the user's feedback during chat sessions, as described elsewhere herein. It should be understood that positive feedback to responses provided by the respective generative AI model 355 for a given intent class may increase the value of the preference metric for that generative AI model 355 and that intent class, whereas negative feedback to responses provided by the respective generative AI model 355 for a given intent class may decrease the value of the preference metric for that generative AI model 355 and that intent class.

The performance metric may measure one or more performance attributes of the respective generative AI model 355, such as computational time, computational speed, usage cost (e.g., in tokens), and/or the like. Initially, the performance metric for a given generative AI model 355 may be based on known, state-of-the-art value(s) of these attribute(s), but may be updated over time based on actual value(s) of these attribute(s) during chat sessions with the user.

The utility metric may measure one or more utility attributes, representing how useful the respective generative AI model 355 is for the respective intent class. For example, a generative AI model 355 that is designed for code completion may have a higher utility metric for the text-to-code class than a generative AI model 355 that is designed for natural-language output. The utility metric may be based on known, state-of-the-art value(s) of these utility attribute(s), but may be updated over time as new information becomes available for the respective generative AI model 355.

The ethics metric may measure one or more ethical attributes, representing how ethical the respective generative AI model 355 is for the respective intent class. For example, these ethical attribute(s) may comprise a measure of human agency and oversight, technical robustness and safety, privacy and data governance, transparency, diversity, non-discrimination and fairness, social and environmental well-being, accountability, and/or the like, for the respective generative AI model 355. The ethics metric may be based on known, state-of-the-art value(s) of these ethical attribute(s), but may be updated over time as new information becomes available for the respective generative AI model 355.

The plurality of generative AI models 355 may comprise any combination of generative AI models. It is generally contemplated that generative AI models 355 would comprise generative language models, such as any of the GPT-n series of models, Claude family of models, Falcon large language model, LLAMA model, Gemini, Mistral, and/or the like. The plurality of generative AI models 355 may also comprise code-completion models, such as the Pathways Language Model (PaLM) released by Google, Codex released by OpenAI, Copilot, Codeium, CodeAI, and/or the like. The plurality of generative AI models 355 may also comprise image-generation models, including text-to-image models, such as the DALL-E n series of models released by OpenAI, the Imagen or Parti models released by Google, Stable Diffusion released by Stability AI, Midjourney released by Midjourney, Inc., of San Francisco, California, and/or the like. It should be understood that these are just examples, and the plurality of generative AI models 355 may comprise any combination of these and/or any other models that generate responses to an input, such as a textual input. In an embodiment, the plurality of generative AI models 355 comprises at least one large language model, including potentially two or more large language models, at least one code-completion model, including potentially two or more code-completion models, at least one text-to-image model, including potentially two or more text-to-image models, and/or the like. When used in the context of integration, at least one, including potentially a plurality or all, of the plurality of generative AI models 355 may be trained on historical integration data collected from a plurality of integration platforms in integration environment 140 of platform 110 as an iPaaS platform.

Module 350 may apply the one of the plurality of generative AI models 355, determined by preference model 345 as the selected generative AI model 355, to the input, to produce a response. For example, module 350 may input the raw input (e.g., as received by module 305) into the selected generative AI model 355. Alternatively, module 350 may pre-process the input and input the pre-processed input into the selected generative AI model 355. Pre-processing the input may comprise formatting the input into a standard format, inserting the input into a predefined template that adds pre-conversation and/or post-conversation to provide context and/or instructions for the selected generative AI model 355, and/or the like. In any case, the output of the selected generative AI model 355 is a response to the input received in module 305. This response may be provided to module 320, to be formatted and displayed as discussed above.

Module 365 receives a reply, to a response that was previously displayed by module 325, by the user via the chat box in the screen of the graphical user interface. A reply is any input that was preceded by another input, such that the reply is subsequent to at least one other input. It should be understood that every input, other than the first input in a chat session, may be considered a reply. Module 365 may essentially be identical to module 305, except that the reply is provided to both module 310 and to module 370. In all other aspects, the description of module 305 may apply equally to module 365. In practice, modules 305 and 365 may be one in the same and comprise logic for determining whether or not the input is a reply, such that module 370 should be triggered.

Module 370 may apply a sentiment model 375 to the reply to predict a sentiment of the reply. Module 370 may be similar or identical to module 330, except that the input is input into sentiment model 375, instead of intent model 335. In addition, sentiment model 375 may be similar to intent model 335, except that sentiment model 375 classifies the input into one of a plurality of sentiment classes, rather than a plurality of intent classes. In all other aspects, the descriptions of module 330 and intent model 335 may apply equally to module 370 and sentiment model 375, respectively.

As mentioned above, in an embodiment, sentiment model 375 may be a classifier that classifies the reply into one of a plurality of sentiment classes. Each of the plurality of sentiment classes may represent a sentiment in the user's reply to a prior response. As an example, the plurality of sentiment classes may comprise a positive class, indicating a positive reaction to the prior response, a negative class, indicating a negative reaction to the prior response, a neutral class, indicating neither a positive nor a negative reaction to the prior response, and/or the like. It should be understood that a positive sentiment indicates that the user reacted positively, in the current reply, to the most recent response, and a negative sentiment indicates that the user reacted negatively, in the current reply, to the most recent response. Thus, the sentiment class, output by sentiment model 375, represents the user's level of satisfaction with the most recent response. It should be understood that these are just examples of the sentiment classes and that the plurality of sentiment classes could comprise different and/or additional classes, including classes representing differing degrees of positive and/or negative reactions. In addition, it should be understood that a positive sentiment may imply that the generative AI model 355, that was used to generate the most recent response, was a good selection by preference model 345, whereas a negative sentiment may imply that the generative AI model 355, that was used to generate the most recent response, was a bad selection by preference model 345.

Sentiment model 375 may comprise any suitable model, including potentially an NER model and/or a machine-learning model, such as a small language model, that is trained to classify the reply into one of the plurality of sentiment classes. Sentiment model 375 may comprise or consist of a language model that is based on the transformer architecture, such as BERT, ROBERTA, ALBERT, DistilBERT, StructBERT, or DeBERTa, a large language model, such as the GPT-n series of large language models, the Claude family of large language models, the Falcon large language model, the LLaMA model, Gemini, or Mistral, and/or the like. Alternatively, sentiment model 375 may comprise another type of machine-learning classifier, or a dictionary-based or rules-based model.

In an embodiment, in which sentiment model 375 comprises a machine-learning model, sentiment model 375 may be trained using supervised learning. In particular, a training dataset may be generated, for example, from historical chat sessions. The training dataset may comprise a plurality of inputs. Each input in the plurality of inputs may be labeled with a ground-truth sentiment class from the plurality of sentiment classes. Over each of a plurality of training iterations, sentiment model 375 may be applied to each of a subset of labeled inputs in the training dataset to produce a predicted sentiment class, the predicted sentiment class may be compared, according to a loss function, to the ground-truth sentiment class with which the input is labeled, and the weights of sentiment model 375 may be updated to minimize the error output by the loss function. Sentiment model 375 may then be evaluated using a different, smaller subset of labeled inputs in the training dataset to determine the accuracy of sentiment model 375 according to a suitable accuracy metric. If sentiment model 375 does not have suitable accuracy (e.g., the value of the accuracy metric is below a predetermined threshold), sentiment model 375 may be retrained until it is able to classify sentiment with suitable accuracy.

In an embodiment, sentiment model 375 may utilize a multi-dimensional vector space. In particular, each input may be converted into a vector embedding representing the location of the input within the vector space, according to an embedding algorithm. Examples of embedding algorithms include, without limitation, Word2Vec, GloVe, TF-IDF, BERT, Doc2Vec, Skip-Thought vector embedding, the PLSI model, LDA, or the like. Each vector embedding may comprise a vector comprising a plurality of values that each represents the value of the input in one of the plurality of dimensions of the vector space. The vector space may represent sentiment, such that the vector embedding represents a location of the vector embedding within a sentiment space. During training, the inputs from historical chat sessions could be converted into vector embeddings, according to the embedding algorithm, and grouped into clusters according to a suitable clustering algorithm (e.g., K-Means), with each cluster representing one of the plurality of sentiment classes. During subsequent operation, sentiment model 375 may convert each input into a vector embedding, according to the same embedding algorithm, determine the nearest cluster to that vector embedding according to any suitable similarity metric (e.g., Euclidean distance, Manhattan distance, Cosine distance, Hamming distance, Minkowski distance, Chebyshev distance, Jaccard distance, Haversine distance, Sorensen-Dice distance, etc.), and output the sentiment class associated with that nearest cluster as the determined sentiment of the input.

Advantageously, the utilization of sentiment model 375 enables the sentiment of a reply to be inferred, unobtrusively and automatically in the background, without requiring an explicit indication from the user. However, in an alternative embodiment, the graphical user interface may comprise one or more inputs by which the user can provide an explicit indication of sentiment. For example, one or more inputs may be provided in the vicinity of each response or in the vicinity of just the most recent response in the screen in which the chat session has been implemented. These input(s) may comprise a first input (e.g., thumbs-up icon, smiley-face icon, etc.) that, when selected by the user, indicates a positive sentiment (i.e., satisfaction with the most recent response), and a second input (e.g., thumbs-down icon, frowny-face icon, etc.) that, when selected by the user, indicates a negative sentiment (i.e., dissatisfaction with the most recent response). In other words, the sentiment is directly determined by which input the user selects. In this alternative embodiment, module 370 and sentiment model 375 may be omitted, and the sentiment may be provided directly to module 380 by module 365 or other module.

The sentiment, inferred by sentiment model 375 (e.g., the sentiment class into which sentiment model 375 classified the reply) or, alternatively, determined directly by the user's selection of a specific input, may be provided to module 380. It should be understood that this sentiment represents the user's feedback. Thus, module 380 may update preference model 345 based on the determined sentiment, as signified by a broken arrow. For example, if the sentiment is positive, the preference metric for the generative AI model 355 that was used to produce the most recent response and for the intent, determined by intent model 335 when generating the most recent response, may be increased relative to the preference metrics for the same intent for all other generative AI models 355. This will increase the probability that the same generative AI model 355 will be selected again for the same intent. Conversely, if the sentiment is negative, the preference metric for the generative AI model 355 that was used to produce the most recent response and for the intent, determined by intent model 335 when generating the most recent response, may be decreased relative to the preference metrics for the same intent for all other generative AI models 355. This will decrease the probability that the same generative AI model 355 will be selected again for the same intent. In an embodiment in which there are a plurality of sentiment classes representing different degrees of positivity and negativity, a more positive response may result in a greater increase to the preference metric than a less positive response, and a more negative response may result in a greater decrease to the preference metric than a less negative response. More generally, when the sentiment to a response is positive, preference model 345 may be updated to increase the probability that the generative AI model 355 that produced the associated response will be selected again for the same intent. Conversely, when the sentiment to a response is negative, preference model 345 may be updated to decrease the probability that the generative AI model 355 that produced the associated response will be selected again for the same intent.

Notably, the application of sentiment model 375 to the reply by module 370 and the update of preference model 345 by module 380 may be done in parallel to the generation of the response to the reply. This is illustrated by the provision of the reply from module 365 to both module 320 and module 370. It should be understood that the response to the reply may be generated in the same manner as described above with respect to the input received by module 305, based on either a gold-standard response 315 or a generative AI response. However, despite being illustrated as parallel paths, in an embodiment, module 380 may be executed in advance of module 340, such that preference model 345 is updated by the sentiment of the reply in advance of the application of preference model 345 to that same reply. Thus, the most recent user feedback, in the form of the determined sentiment, may be incorporated into preference model 345 prior to its next use.

### 4. PROCESS

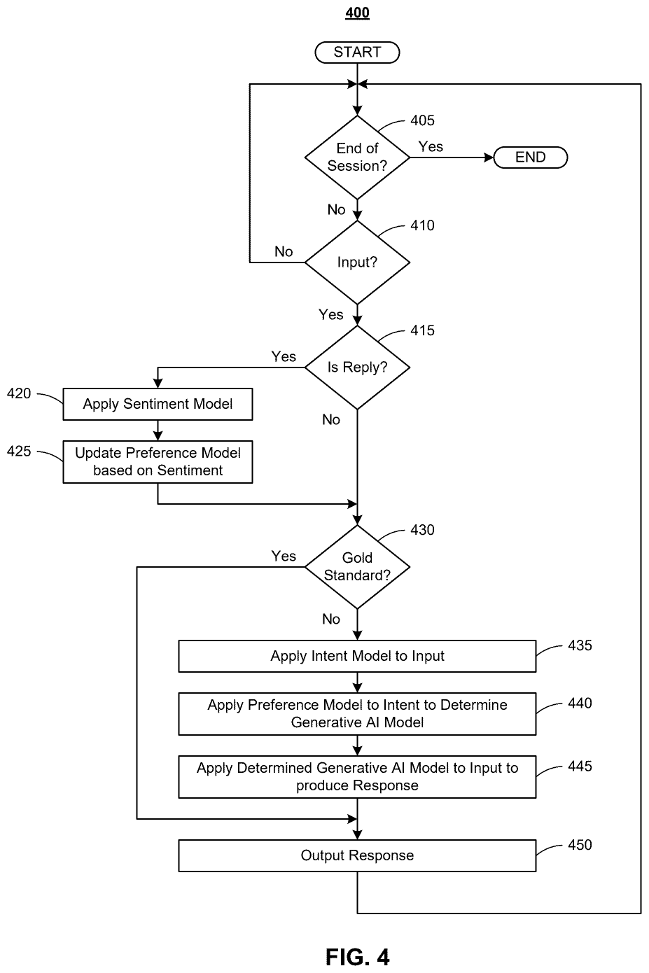

FIG. 4 illustrates a process 400 for a collaborative AI preference model for generative AI model selection, according to an embodiment. Process 400 may be implemented in server application 112. While process 400 is illustrated with a certain arrangement and ordering of subprocesses, process 400 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Process 400 may be triggered whenever a user starts a new session, such as a new chat session, and, during the session, execute in each of one or more, and generally a plurality of, iterations. The session may occur within a single screen of a graphical user interface of user interface 150. The screen may comprise a chat box, which is configured to receive inputs, and an area (e.g., above or below the chat box) in which each response is displayed. Thus, each input is received through the chat box, and each response is displayed on the screen, such that the screen provides a real-time dialogue between the user and the chatbot, implemented by AI model 116.

In an embodiment, the graphical user interface is implemented by server application 112 of an iPaaS platform, such as the Boomi® iPaaS platform, as platform 110. In this case, the chat session may be intended to provide information about integration, including information about integration processes 160, components of integration processes 160, integration platforms, integration in general, and the like, to the user. At least one, and potentially all, of the plurality of generative AI models 355 may be trained on historical integration data collected from a plurality of integration platforms on the iPaaS platform. In particular, the iPaaS platform may support a plurality of integration platforms, each managed by a different organizational account that is associated with one or more user accounts. Thus, the historical integration data may represent a massive repository of previously implemented integration processes 160 that is very diverse in terms of structures, configurations, applications, inputs and outputs, and the like, and potentially crowd-sourced from a diverse group of organizations (e.g., different sizes, different locations, different industries, etc.).

Subprocess 405 determines whether or not to end the session. Subprocess 405 may determine to end the session when the user navigates away from the screen on which the session was occurring, after a timeout (e.g., after a timer, which was started from the user's last input, has expired), and/or the like. When determining to end the session (i.e., “Yes” in subprocess 405), process 400 may end. Otherwise, when not determining to end the session (i.e., “No” in subprocess 405), process 400 may proceed to subprocess 410.

Subprocess 410, which may be implemented by module 305 and/or 365, determines whether or not a new input has been received via the graphical user interface. Subprocess 410 may determine that a new input has been received whenever the user inputs text into the chat box on the screen and submits that text, for example, by selecting an input associated with the chat box. In an alternative or additional embodiment which provides an application programming interface, subprocess 410 may determine that a new input has been received whenever an input is received as an input parameter to a function of the application programming interface. When determining that a new input has been received (i.e., “Yes” in subprocess 410), process 400 may proceed to subprocess 415. Otherwise, when not determining that a new input has been received (i.e., “No” in subprocess 410), process 400 may return to subprocess 405 to await either the end of the session or the next input.

Subprocess 415, which may be implemented by module 365, determines whether or not the input, received in subprocess 410, is a reply to a prior response. Subprocess 415 may determine that the input is a reply whenever there is at least one prior response in the session. In other words, subprocess 415 may determine that the input is not a reply in the first iteration of subprocess 415, and determine that the input is a reply in all subsequent iterations of subprocess 415. When determining that the input is a reply (i.e., “Yes” in subprocess 415), process 400 may proceed to subprocess 420. Otherwise, when determining that the input is not a reply (i.e., “No” in subprocess 415), process 400 may proceed to subprocess 430.

Subprocess 420, which may be implemented by module 370, may apply sentiment model 375 to the reply to predict a sentiment of the reply. It should be understood that, when there are a plurality of iterations in process 400, subprocess 420 will be performed in each iteration that is subsequent to the first iteration. Sentiment model 375 may comprise a classifier, such as a machine-learning classifier, that classifies the reply into one of a plurality of sentiment classes. The predicted sentiment will comprise the one sentiment class into which sentiment model 375 classified the reply. The plurality of sentiment classes may comprise or consist of a positive class, indicating a positive reaction to the prior response, and a negative class, indicating a negative reaction to the prior response. The plurality of sentiment classes could also comprise a neutral class, indicating neither a positive nor a negative reaction to the prior response. It should be understood that these are just examples and that the plurality of sentiment classes could comprise different and/or additional classes, including classes representing differing degrees of positive and/or negative reactions.

Subprocess 425, which may be implemented by module 380, may update preference model 345 based on the predicted sentiment, output by subprocess 420. As discussed elsewhere herein, preference model 345 may comprise, for each of a plurality of intent classes and for each of the plurality of generative AI models 355, a preference score. The preference score for each intent class and generative AI model 355 may be computed from a preference metric, performance metric, utility metric, ethics metric, and/or the like. Subprocess 425 may update the preference metric based on the predicted sentiment, for example, by increasing the preference metric when the sentiment is classified as positive, and decreasing the preference metric when the sentiment is classified as negative. Thus, preference model 345 is continually updated and improved for each specific user utilizing reinforcement learning from human feedback (RLHF). It should be understood that preference model 345 for each user will persist over all sessions between that user and the chatbot, such that the preference scores at the end of each session will carry over to the start of the next session between that user and the chatbot.

Subprocess 430, which may be implemented by module 310, may determine whether or not a gold-standard response 315 exists for the input, received in subprocess 410. In particular, subprocess 430 may perform a lookup on a table comprising gold-standard responses 315 or otherwise attempt to retrieve a gold-standard response 315, based on a representation of the input (e.g., the exact input, a portion of the input, a set of keywords representing the input, etc.). When a gold-standard response 315 is returned, subprocess 430 may determine that a gold-standard response 315 exists for the input. Conversely, when no gold-standard response 315 is returned, subprocess 430 may determine that no gold-standard response 315 exists for the input. When determining that a gold-standard response 315 exists for the input (i.e., “Yes” in subprocess 430), process 400 may proceed to subprocess 450, to use the retrieved gold-standard response 315 as the response to the input. Otherwise, when determining that no gold-standard response 315 exists for the input (i.e., “No” in subprocess 430), process 400 may proceed to subprocess 435, to produce a generative AI response to the input.

Subprocess 435, which may be implemented by module 330, may apply intent model 335 to the input, received in subprocess 410, to determine an intent of the input. As discussed elsewhere herein, intent model 335 may comprise a classifier, such as a machine-learning classifier, that classifies the input into one of a plurality of intent classes. It should be understood that the determined intent will comprise the one intent class into which intent model 335 classified the input. The plurality of intent classes may comprise or consist of a summarization class, indicating that the user is requesting a summarization of information, a question-and-answer class, indicating that the user is asking a question, a text-to-code class, indicating that the user is requesting source code to be generated, and/or the like. In an embodiment, the plurality of intent classes comprises or consists of all three of the summarization class, the question-and-answer class, and the text-to-code class. It should be understood that these are just examples and that the plurality of intent classes could comprise different and/or additional classes.

Subprocess 440, which may be implemented by module 340, may apply preference model 345 to the intent, determined in subprocess 435, to determine one of the plurality of generative AI models 355 to be used to generate the generative AI response. Essentially, preference model 345 is used to select one of the plurality of generative AI models 355. As discussed elsewhere herein, preference model 345 may determine one of the plurality of generative AI models 355 based on the preference scores for the intent class, output by subprocess 435, across the plurality of generative AI models 355. In particular, preference model 345 may select the one generative AI model 355 with the highest preference score for the determined intent class. As discussed elsewhere herein, this preference score may be computed based on a preference metric, performance metric, utility metric, ethics metric, and/or the like. Over time, the preference metric for each generative AI model 355 may be updated based on user feedback (e.g., in subprocess 425). The performance metric, utility metric, and/or ethics metric could also be updated over time based on new information collected for each generative AI model 355.

Subprocess 445, which may be implemented by module 350, may apply the generative AI model 355, determined by preference model 345 in subprocess 440, to the input, received in subprocess 410, to produce a generative AI response. In particular, the raw or pre-processed input may be input into the selected generative AI model 355 to produce the generative AI response. Depending on the input and/or the selected generative AI model 355, the response could comprise a natural-language expression, source code, an image, and/or the like. The plurality of generative AI models 355 may comprise at least one large language model, including potentially a plurality of different large language models, at least one code-completion model, including potentially a plurality of different code-completion models, at least one text-to-image model, including potentially a plurality of different text-to-image models, and/or the like.

Subprocess 450, which may be implemented by modules 320 and/or 325, may output the raw or formatted response. In particular, the response may be displayed to the user within the graphical user interface, for example, within the screen implementing the chat session. The response may be displayed near the input to which it is responding (e.g., above or below the input). It should be understood that this response may either be a gold-standard response 315, output by subprocess 430, or a generative AI response, output by subprocess 445. In particular, when determining that a gold-standard response 315 exists for the input, received in subprocess 410, in subprocess 430, that gold-standard response 315 is displayed to the user within the graphical user interface without producing a generative AI response. On the other hand, when determining that a gold-standard response 315 does not exist for the input, received in subprocess 410, in subprocess 430, a generative AI response is produced by subprocesses 435-445 and displayed to the user within the graphical user interface. In an alternative or additional embodiment which provides an application programming interface, outputting the response may comprise sending the response to an external system in response to a call to a function of the application programming interface.

Embodiments have primarily been described herein as applying preference model 345 to select a single one of generative AI models 355. In an alternative embodiment, module 340 may apply preference model 345, in subprocess 440, to select an ensemble of two or more generative AI models 355 from the plurality of generative AI models 355. For example, for a given intent, preference model 345 may select two or more generative AI models 355 with the highest preference scores. The number of generative AI models 355 that are selected may be a predefined number (e.g., the top two or three generative AI models 355 in terms of preference scores). Alternatively, preference model 345 may select each generative AI model 355 with a preference score above a predefined threshold. In any case, when a subset of two or more of the plurality of generative AI models 355 are selected, module 350, in subprocess 445, may apply each generative AI model 355 in the subset to the input, and then generate a composite response based on the response from each of those generative AI models 355. The composite response may be generated by selecting a single one of the responses as the response based on some metric that is applied to each response, or combining two or more, including potentially all, of the response into a single response using any suitable technique.

### 5. GRAPHICAL USER INTERFACE

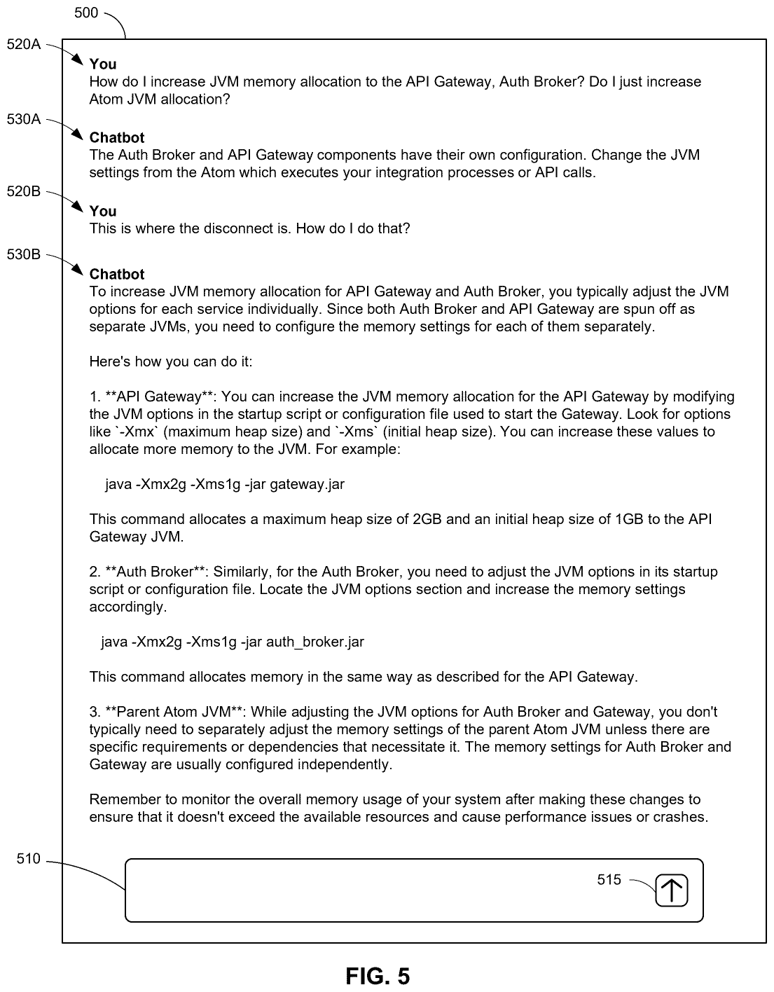

FIG. 5 illustrates a screen 500 of a graphical user interface, implementing a chat session, according to an embodiment. Screen 500 may be generated by server application 112, as part of user interface 150. As illustrated, screen 500 may comprise a chat box 510. Chat box 510 is configured to receive input from a user. While it is generally contemplated that the input will comprise or consist of text, such as a natural-language expression, a list, source code, and/or the like, the input could additionally or alternatively comprise or consist of images, video, audio, and/or the like. The user may submit the input, which the user has input into chat box 510, by selecting a submission input 515. Selection of submission input 515 may trigger module 305 for the initial input in the chat session and/or module 365 for all subsequent inputs in the chat session.

In the illustrated example, the chatbot has been designed to support an iPaaS platform. The user has submitted two inputs 520A and 520B, which are both displayed in screen 500, and received two responses 530A and 530B, which are also both displayed in screen 500 near (i.e., immediately below) their respective inputs 520. In particular, response 530A is a response to input 520A, and response 530B is a response to input 520B.

Initially, the user submitted input 520A, which asked an integration-related question. Once submitted, input 520A was displayed on screen 500. In addition, the submission of input 520A triggered process 400, which executed an iteration of subprocesses 435-445 to produce a generative AI response. This response was then displayed on screen 500 as response 530A, under input 520A, in subprocess 450. Notably, response 530A consists of a natural-language expression.

In this first iteration of producing a generative AI response, a first one of the plurality of generative AI models 355 was selected based on preference model 345. For example, the intent may have been classified into the question-and-answer class, and this first generative AI model 355 may have been associated with the highest preference score, from among all generative AI models 355, for the question-and-answer class. Accordingly, preference model 345 selected the first generative AI model 355 based on it having the highest preference score for the given intent, and the first generative AI model 355 outputted response 530A.

Subsequently, the user replied with input and reply 520B. Once submitted, reply 520B was displayed on screen 500, under response 530A. In addition, the submission of reply 520B triggered another iteration of subprocesses 435-445. Notably, reply 520B expresses dissatisfaction with response 530A. In particular, the user did not feel that response 530A sufficiently answered their question. Accordingly, sentiment model 375, when applied by module 370 in subprocess 420, classified the sentiment of reply 520B as negative. Consequently, preference model 345 was updated by module 380 in subprocess 425. This update happened to change the preference scores for the plurality of generative AI models 355 (e.g., by decreasing the preference metric for the first generative AI model 355), such that a second generative AI model 355 was now associated with the highest preference score, from among all generative AI models 355 (i.e., including the first generative AI model 355), for the question-and-answer class. Thus, assuming that the intent is again classified into the question-and-answer class in subprocess 435, when preference model 345 is applied in subprocess 440, this second generative AI model 355 is selected to generate the generative AI response 530B, instead of the first generative AI model 355 that was used to generate the first generative AI response 530A, since the second generative AI model 355 now has the highest preference score for the given intent.

Notably, response 530B comprises both natural-language expressions and code (e.g., command-line inputs), in an easy-to-follow list format. Thus, response 530B represents a vast improvement over response 530A, and includes specific details that are directly related to the user's question. Accordingly, the user is likely to be much more satisfied with response 530B. It should be understood that preference model 345 will persist across all chat sessions between the user and the chatbot. Thus, the second generative AI model 355 may continue to be selected over the first generative AI model 355, if the intent is classified into the question-and-answer class in a subsequent chat session that the user initiates.

### 6. APPLICATION PROGRAMMING INTERFACE

In an embodiment, user interface 150 may comprise an application programming interface that enables an external system (i.e., external to platform 110) to communicate with server application 112 directly. For instance, the application programming interface may provide access to modules 305, 325, and 365. Access to these modules may be restricted to authenticated users via an API key.

From the perspective of the application programming interface, these modules may be implemented as one function which accepts the user's input as an input parameter and returns the response, whether a gold-standard response 315 or generative AI response, as an output parameter. In other words, modules 305, 325, and 365 may all be implemented as a single API function. Each input that is received after the first input within the same API session, may be automatically designated as a reply and forwarded, by the function of the application programming interface, to module 370 for sentiment processing, as disclosed elsewhere herein.

In an embodiment that utilizes such an application programming interface, the graphical user interface, including potentially screen 500, may be implemented by another system, such as user system 130, a third-party system 170, and/or the like. When receiving an input (e.g., in the chat box of screen 500), this other system may execute a remote procedure call to the function of the application programming interface, using the input as an input parameter, and receive the response to the input as an output parameter of the remote procedure call. This other system may then display the response on screen 500, as described elsewhere herein. In other words, server application 112 provides all of the functionality for generating the responses, and the other system provides the graphical user interface.

### 7. CONCLUSION

Advantageously, the chatbot of disclosed embodiments represents a concierge for all questions or requests related to the given context (e.g., integration). The user may submit queries in natural language within an easy-to-use and intuitive graphical user interface that collects feedback in the background for continuous improvement. This empowers the user to improve the system and enhance their own user experience, as well as the user experience of others. In addition, the chatbot utilizes artificial intelligence, and particularly preference model 345, to intelligently select one or more of the plurality of generative AI models 355 based on query relevance, historical accuracy and performance, utility, ethics, and/or the like. This provides enhanced reliability, transparency, trust, and user confidence in the system.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to, during a session with a user, in each of one or more iterations:
receive an input from the user via a graphical user interface; and
produce a generative artificial intelligence (AI) response by
applying an intent model to the input to determine an intent of the input,
applying a preference model to the determined intent to determine at least one of a plurality of generative artificial intelligence (AI) models,
applying the determined at least one of the plurality of generative AI models to the input to produce a response, and
displaying the response to the user within the graphical user interface.

2. The method of claim 1, wherein the intent model comprises a classifier that classifies the input into one of a plurality of intent classes, and wherein the determined intent comprises the one intent class into which the intent model classified the input.

3. The method of claim 2, wherein the intent model comprises a machine-learning classifier.

4. The method of claim 2, wherein the preference model comprises, for each of the plurality of intent classes and for each of the plurality of generative AI models, a preference score, and wherein the preference model determines the at least one of the plurality of generative AI models based on the preference scores for the one intent class across the plurality of generative AI models.

5. The method of claim 2, wherein the plurality of intent classes comprises one or more of a summarization class, indicating that the user is requesting a summarization of information, a question-and-answer class, indicating that the user is asking a question, or a text-to-code class, indicating that the user is requesting source code to be generated.

6. The method of claim 5, wherein the plurality of intent classes comprises the summarization class, the question-and-answer class, and the text-to-code class.

7. The method of claim 1, wherein the one or more iterations are a plurality of iterations, and wherein the method further comprises using the at least one hardware processor to, during the session with the user, in at least one of the plurality of iterations that is subsequent to a first iteration, such that the input is a reply to a prior response:
apply a sentiment model to the reply to predict a sentiment of the reply; and
update the preference model based on the predicted sentiment.

8. The method of claim 7, wherein the sentiment model comprises a classifier that classifies the reply into one of a plurality of sentiment classes, and wherein the predicted sentiment comprises the one sentiment class into which the sentiment model classified the reply.

9. The method of claim 8, wherein the sentiment model comprises a machine-learning classifier.

10. The method of claim 8, wherein the plurality of sentiment classes comprises a positive class, indicating a positive reaction to the prior response, and a negative class, indicating a negative reaction to the prior response.

11. The method of claim 1, wherein the plurality of generative AI models comprises at least one large language model.

12. The method of claim 11, wherein the plurality of generative AI models comprises at least one code-completion model.

13. The method of claim 1, wherein the plurality of generative AI models comprises two or more large language models.

14. The method of claim 1, further comprising using the at least one hardware processor to, in at least one of the one or more iterations, determine whether or not a gold-standard response exists for the input.

15. The method of claim 1, wherein the one or more iterations are a subset of a plurality of iterations, and wherein the method further comprises using the at least one hardware processor to, in at least one of the plurality of iterations:
determine whether or not a gold-standard response exists for the input;
when determining that the gold-standard response exists for the input, display the gold-standard response to the user within the graphical user interface without producing the generative AI response; and
when determining that the gold-standard response does not exist for the input, produce the generative AI response.

16. The method of claim 1, wherein the graphical user interface comprises a screen that includes a chat box, wherein each input is received through the chat box, and wherein each response is displayed on the screen.

17. The method of claim 16, wherein the graphical user interface is implemented by a server application of an Integration Platform as a Service (iPaaS) platform.

18. The method of claim 17, wherein at least one of the plurality of generative AI models is trained on historical integration data collected from a plurality of integration platforms on the iPaaS platform.

19. A system comprising:
at least one hardware processor; and
software that is configured to, when executed by the at least one hardware processor, during a session with a user, in each of one or more iterations,
receive an input from the user via a graphical user interface; and
produce a generative artificial intelligence (AI) response by
applying an intent model to the input to determine an intent of the input,
applying a preference model to the determined intent to determine at least one of a plurality of generative artificial intelligence (AI) models,
applying the determined at least one of the plurality of generative AI models to the input to produce a response, and
displaying the response to the user within the graphical user interface.

20. A non-transitory computer-readable medium having instructions stored therein, wherein the instructions, when executed by a processor, cause the processor to, during a session with a user, in each of one or more iterations:
receive an input from the user via a graphical user interface; and
produce a generative artificial intelligence (AI) response by
applying an intent model to the input to determine an intent of the input,
applying a preference model to the determined intent to determine at least one of a plurality of generative artificial intelligence (AI) models,
applying the determined at least one of the plurality of generative AI models to the input to produce a response, and
displaying the response to the user within the graphical user interface.
